(19) United States
(12) Patent Application Publication
(10) Pub. No.: US 2015/0284984 A1
(43) Pub. Date: Oct. 8, 2015

(54) Method and device for opening a door of a vehicle

(71) Applicant: ROBERT BOSCH GMBH, Stuttgart (DE)

(72) Inventors: Pascal Kanter, Peissenberg (DE); Henning Voelz, Stuttgart (DE)

(21) Appl. No.: 14/646,882

(22) PCT Filed: Dec. 3, 2013
(86) PCT No.: PCT/EP2013/075348

§ 371 Date: May 22, 2015

(30) Foreign Application Priority Data
Dec. 4, 2012 (DE) 10 2012 222 175.1

(51) Int. Cl. E05F 15/74; B60R 25/24; B60R 25/25; B60J 5/00; E05F 15/76

(52) U.S. Cl. CPC E05F 15/74; B60J 5/00; E05F 15/76; B60R 25/25; B60R 25/24; E05F 2015/765

(57) ABSTRACT

A method for opening a door of a vehicle includes: a step of identifying an authorization device for use of the vehicle approaching the vehicle; a step of detecting when the authorization device approaches a relevant door of the vehicle; and a step of activating a unit for opening the relevant door.

### BACKGROUND OF THE INVENTION

1. Field of the Invention

The present invention relates to a method for opening a door of a vehicle, to a corresponding device, and to a corresponding computer program product.

2. Description of the Related Art

At present, most vehicles are equipped as standard with a central locking system which may be activated by remote control—e.g., by pressing a button on the ignition key—to unlock the vehicle. A carrier of the ignition key may then open one of the vehicle doors by pulling a door handle to gain access to the interior of the vehicle.

Several manufacturers offer systems in which the trunk may be automatically opened, or the vehicle may be automatically unlocked or locked upon approaching or moving away from the same, with the aid of the radio remote control of the key. Such systems are available from premium manufacturers, but increasingly also in the high-volume segment.

Published German patent document DE 199 52 854 C1 discloses an assistance device in a vehicle, which is used to create a user profile for a driver and retrieve it for the driver. The assistance device includes a processor, which is connected to means for person recognition. The user profile is changed in accordance with the instantaneous settings of a user.

### BRIEF SUMMARY OF THE INVENTION

Against this background, the present invention introduces a method for opening a door of a vehicle, furthermore a device which uses this method, and finally a corresponding computer program product.

A concept for automatically opening a certain door of a vehicle when approaching the vehicle allows unimpaired access to the interior of the vehicle at the particular door.

According to the approach described here, for example, a person who approaches the vehicle and carries objects, and thus does not have a free hand, is able to enter or load the vehicle without first having to set the objects aside to open the vehicle door and load the objects. The objects may be groceries, for example. The concept described here may also be used to advantageously facilitate placing a child carried on the arm into a child seat of the vehicle. The system described here thus has a major advantage, among other things, e.g., in the following scenario. A mother approaches the vehicle with a child on her arm, which would make the opening of the corresponding door by hand considerably more difficult. Here, the vehicle is able to already open the door for the driver. Moreover, the system would also mean relief for older people.

An existing surround view system could be enhanced without additional cost. A motor for the trunk lid is already present in many vehicles; for the other doors, such a motor could be additionally integrated without major additional complexity.

A method for opening a door of a vehicle includes the following steps:

identifying an authorization unit for use of the vehicle approaching the vehicle;
detecting the authorization unit approaching a relevant door of the vehicle; and
activating a unit for opening the relevant door.

The method may be carried out using a control unit of the vehicle, for example in the form of a device for opening a door of a vehicle. The vehicle may be a road vehicle such as a passenger car or a truck. In the case of a five-door vehicle, e.g., the door may be a driver door, a passenger door, a left or right rear door, or a tailgate or a trunk lid of the vehicle. For example, the door may be designed as a swing or hinged door, or as a sliding door. The opening of the door may be understood to mean that the unlocked door is moved about a hinge or along a rail in such a way that an opening to the vehicle interior is exposed, for example for entering the vehicle or for loading the vehicle with objects to be transported. The authorization unit for use of the vehicle may be designed to cause the vehicle to be unlocked, opened and started, for example. In corresponding fashion, the authorization unit may be an ignition key, for example. This key may be equipped with a radio transmitter, e.g., so that the vehicle may be unlocked already from a distance by pressing a button of the ignition key. As an alternative, the authorization unit may be part of a keyless unlocking system, with which a vehicle may be unlocked without actively using a car key and started, e.g., at the push of a button. The authorization unit may include a transponder which is designed to receive an inquiry signal emitted by a communication unit situated on the vehicle, and to emit a response signal to the communication unit in response to receipt of the inquiry signal. The communication unit may be designed to identify the authorization unit using the response signal. The authorization unit may be designed to withdraw the necessary energy for emitting the response signal from the inquiry signal. The step of identifying the authorization unit may be carried out in that a signal exchange takes place, e.g., by radio, between the authorization unit and the vehicle as soon as the authorization unit is within a predetermined perimeter around the vehicle. The authorization unit may include a chip card or a radio frequency identification (RFID) transponder, for example, which are equipped with an authorization code for the vehicle which may be transmitted by radio to the vehicle. When the authorization code is detected by the vehicle, the authorization unit may be successfully identified based on this code. For example, one door or all doors of the vehicle may be automatically unlocked after successful identification. The use of the vehicle may be understood to mean that one or multiple persons may enter the vehicle or load it and/or a person may start the vehicle and use it for transportation. The step of detecting may be carried out using one or multiple optical sensors of the vehicle. In this way, for example, a person carrying the authorization unit may be detected and tracked. In a supporting manner or as an alternative, a radar or LIDAR sensor may also be used, e.g., for this purpose. A progression of the approaching of the vehicle may be detected, for example, in relation to a directional progression, a speed progression or an end point of the approach. The relevant door may be selected by evaluating the approach, the progression of the approach, or one or multiple characteristic features of the approach. Such an evaluation may take place, for example, using stored reference approaches or stored reference patterns. The relevant door may be a door which a person activates when approaching the vehicle in order to gain access there to the interior of the vehicle. The relevant door may also be referred to as a so-called “door of interest.” The unit for opening the relevant door may be a motor, for example, which is set into operation in response to the step of activating to open the relevant door and expose the opening to the vehicle interior. The activation of the unit for opening the relevant door may be carried out by the control unit of the vehicle.

According to one specific embodiment of the method, a movement trajectory of the authorization unit in relation to the vehicle may be detected in the step of detecting the approaching. The method may include a step of ascertaining the relevant door in which, based on the movement trajectory of the authorization unit, a door of the vehicle which is assignable to the movement trajectory is ascertained as the relevant door. The movement trajectory may be understood to mean a space curve along which the authorization unit is moving toward the vehicle. This may be done, for example, in that a person carrying the authorization unit approaches the vehicle on the movement trajectory. The detection may be carried out, for example, with the aid of a camera system of the vehicle, which includes the optical sensor or sensors. It is useful to carry out an optical flow method here, for example. The relevant door may be ascertained, for example, by ascertaining, in the step of detecting, the door among all doors of the vehicle which is situated closest to the movement trajectory as the relevant door. This specific embodiment has the advantage that a localization to the relevant door may be achieved with a very low error rate.

In the step of ascertaining, it is also possible to select an approach profile which is assigned to the movement trajectory from multiple approach profiles which are assigned to different doors of the vehicle in order to ascertain the relevant door. An approach profile assigned to a door of the vehicle may include, for example, multiple movement trajectories deviating from each other up to a certain degree. The different movement trajectories may be learned by a system using the method, for example, by multiple repetition. The method may use classifiers for the useful storage of multiple movement trajectories in different approach profiles. In this specific embodiment, the determination of the relevant door may advantageously be carried out even more quickly and accurately. The process may thus also be designed to be more robust, since a minor deviation of the authorization deviation from the movement trajectory may be tolerated and does not result in the process being terminated.

According to one further specific embodiment, the method may include a step of a facial detection of a person carrying the authorization unit. In the step of facial detection, it may be checked based on the facial detection whether the person carrying the authorization unit is a person authorized to use the vehicle. In corresponding fashion, the unit for opening the relevant door is only activatable in the step of activating if it was established in the step of facial detection that the person carrying the authorization unit is authorized to use the vehicle. The facial detection may be carried out with the aid of a camera system of the vehicle. The person may carry the authorization unit, for example, by holding it in his or her hand or, for example, by having inserted it into a pocket of a piece of clothing the person is wearing. With this specific embodiment of the method, effective theft protection for the vehicle, or for objects situated in the vehicle, may be achieved in a simple manner.

In particular, the authorized person may be selected from multiple authorized persons in the step of facial detection. Classifiers may also be used in this specific embodiment of the method to select the authorized persons. This specific embodiment of the method has the advantage that an owner of the vehicle, e.g., is able to determine which persons from his or her circle should be authorized to use the vehicle. In view of this user-friendly safety aspect, it may be assumed that interest from buyers will be great in a vehicle which is equipped with a corresponding system.

The method may furthermore include a step of checking a swing range of the relevant door. In corresponding fashion, the unit for opening the relevant door may only be activated in the step of activating if it was established in the step of checking a swing range that the swing range is free of obstacles. To check the swing range, in turn, a camera system of the vehicle which includes the optical sensor may, in some circumstances, be supplemented or replaced with a radar or LIDAR sensor. The swing range of the door may be understood to mean the region of vehicle surroundings which the door traverses when it is swung open up to a stop. This specific embodiment has the advantage that damage to the door by an obstacle situated in the swing range is preventable.

In particular, the unit for opening the relevant door may be stopped and/or an opening of the relevant door may be stopped in the step of activating if it was established in the step of checking a swing range that a moving obstacle has entered the swing range of the relevant door. In this way it is advantageously preventable that, e.g., persons moving past the vehicle on foot or on a bicycle, e.g., are put at risk by the automatic opening of the door.

A device for opening a door of a vehicle includes the following features:

a unit for identifying an authorization unit for use of the vehicle approaching the vehicle;
a unit for detecting when the authorization unit approaches a relevant door of the vehicle; and
a unit for opening the relevant door.

The device may be coupled to a camera system of the vehicle and/or to a central control unit of the vehicle. The unit for opening the relevant door may be a motor which is integrated into the door.

The device may be designed to carry out or implement the steps of the method according to the present invention in the corresponding units. The object of the present invention may also be achieved quickly and efficiently by this embodiment variant of the present invention in the form a device.

A device in the present invention may be understood to mean an electrical device which processes sensor signals and outputs control and/or data signals as a function thereof. The device may include an interface which may be designed as hardware and/or software. In the case of a hardware design, the interfaces may, for example, be part of a so-called system ASIC which includes a wide variety of functions of the device. However, it is also possible for the interfaces to be separate integrated circuits, or to be at least partially composed of discrete components. In the case of a software design, the interfaces may be software modules which are present on a microcontroller, for example, in addition to other software modules.

According to one specific embodiment, the device may furthermore include at least one optical sensor. The optical sensor may be designed to detect when the authorization unit approaches a relevant door of the vehicle and/or to detect a movement trajectory of the authorization unit and/or to carry out a facial detection of a person carrying the authorization unit and/or to check a swing range of the relevant door. The optical sensor may be part of a camera system of the vehicle or be directly coupled thereto. It is also possible to use multiple optical sensors. When using four optical sensors, for example, a first optical sensor may be situated in a left outside mirror of the vehicle, a second optical sensor in the right outside mirror of the vehicle, a third optical sensor in a front region of the vehicle, and a fourth optical sensor on a rear of the vehicle, so that surroundings of the vehicle may be viewed and monitored fully by the camera system, in the form of a surround view. Advantageously, even production vehicles are meanwhile already equipped with such a camera system as a parking assistance system, so that the device is able to use already present elements for the purposes according to the present invention.

In addition, a computer program product is advantageous, having program code which may be stored on a machine-readable carrier such as a semiconductor memory, a hard disk memory or an optical memory, and which is used to carry out the method according to one of the specific embodiments described above, if the program product is executed on a computer or a device.

The present invention is described in greater detail hereafter based on the accompanying drawings by way of example.

### BRIEF DESCRIPTION OF THE DRAWINGS

FIG. 1 shows a representative illustration of a vehicle having a device for opening a door of the vehicle according to one exemplary embodiment of the present invention.

FIG. 2 shows a flow chart of a method for opening a door of a vehicle according to one exemplary embodiment of the present invention.

### DETAILED DESCRIPTION OF THE INVENTION

In the following description of preferred exemplary embodiments of the present invention, identical or similar reference numerals are used for similarly acting elements shown in the different figures, and a repeated description of these elements is dispensed with.

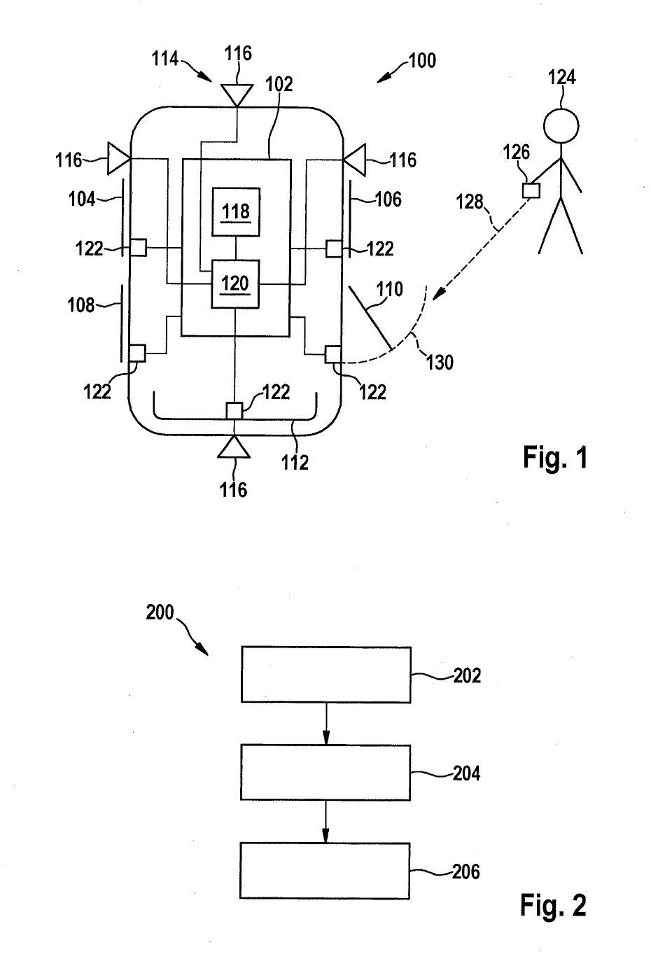

FIG. 1 shows a representative illustration of a vehicle 100 with one exemplary embodiment of a device 102 for opening a door of vehicle 100. As a five-door vehicle, the vehicle is equipped with a driver door 104, a passenger door 106, a left rear door 108, a right rear door 110 and a tailgate 112. Vehicle 100 furthermore includes a camera system 114 having optical sensors 116. In vehicle 100 shown in FIG. 1, camera system 114 includes four optical sensors 116, of which one is situated in a front region of vehicle 100, one on the rear of vehicle 100, and two additional ones in each case laterally on vehicle 100. For example, lateral optical sensor 116 may be integrated into a left and right outside mirror of vehicle 100. Device 102 includes a unit 118 for identifying an authorization unit for use of vehicle 100 approaching the vehicle, a unit 120 for detecting when the authorization unit approaches a relevant door of the vehicle, and a unit 122 for opening the relevant door. Unit 122 is a motor for opening a vehicle door in the exemplary embodiment of device 102 shown in FIG. 1. Vehicle 100 shown in the figure is equipped with such a motor 122 on all five doors 104, 106, 108, 110, 112. Device 102 is coupled to camera system 114 of the vehicle via a line system of vehicle 100, for example via a CAN bus. Based on its function, unit 122 for opening the relevant door is situated decentrally and also coupled via lines to device 102. Device 102 may integrate a central control unit of the vehicle or be coupled to such a control unit. Device 102 may also be connected to a driver assistance system of vehicle 100. Camera system 114 may be part of the driver assistance system.

In the scene shown in FIG. 1, a person 124 carrying an authorization unit 126 for use of vehicle 100 approaches vehicle 100. Person 124 is the driver of vehicle 100, for example. Authorization unit 126, in the form of a “key,” empowers person 124 carrying the unit to enter the vehicle, load it, and start the drive engine, for example. Unit 118 identifies authorization unit 126, for example via radio. In response to the identification, camera system 114 of vehicle 100 detects a movement trajectory 128 which is indicated with the aid of a dotted directional arrow and on which authorization unit 126, together with person 124, is moving toward the vehicle. An optical flow method may be used, for example, for the optical detection of a progression of movement trajectory 128. Using a suitable algorithm, for example, movement trajectory 128 is assigned to a relevant door of vehicle 100, here right rear door 110, in unit 120. Motor 122 of right rear door 110 is accordingly activated. Motor 122 opens right rear door 110 for the person moving toward vehicle 100 or for key owner 124.

The system or device 102 detects via optical sensors 116 when key owner 124 approaches vehicle 100, which may be implemented as a so-called series sensor, for example. Vehicle 100 is unlocked by system 102. The image-processing system or camera system 114 is activated and detects key owner 124. Key owner 124 is tracked via image-processing system 114, and the movement direction or movement trajectory 128 is determined. When key owner 124 is moving toward a door, here right rear door 110, or trunk 112 of vehicle 100, the corresponding door, here right rear door 110, is opened automatically. A different movement trajectory having a different progression would be used as the basis for opening tailgate 112. The detection and the tracking may be carried out using known algorithms, for example. Methods using trained classifiers and/or optical flow method may be used for this purpose. Possible methods are known for monitoring in safety technology systems, but also for person recognition in camera systems in the vehicle, and are under development or being produced.

Image-processing system 114—if necessary, with the aid of other sensors such as ultrasound—optionally detects whether it is safe at a particular moment to open vehicle door 110 at a particular location.

In one particular embodiment of device 102, the face of the driver of the vehicle or of dedicated persons, such as person 124, may be “learned” by system 102. System 102 is then appropriately calibrated or initialized. This has the advantage that door 110 is only opened for known passengers and not for any arbitrary person who happens to approach the vehicle simultaneously with driver 124, for example.

It is also important in this context that, prior to the opening of door 110, vehicle 100 must check that door 110 does not strike against other objects and door 110 or the object is thus damaged. Moreover, a swing range 130 of relevant door 110—indicated in the illustration in FIG. 1 with the aid of a dotted curved line—must be monitored, so that no moving object enters door swing range 130 while the door is being opened and is thus put at risk. For example, putting a bicyclist at risk may thus be avoided, if swing range 130 of door 110 extends into a bicycle lane. The two latter requirements are also implementable with close-range camera 114 used for this system 102.

Device 102 for opening a door of a vehicle may be coupled to a driver assistance system for assisting driver 124, or also for vehicle driving during parking. Such driver assistance systems are already being produced. One of the systems is a surround-view system, according to which camera system 114 of vehicle 100 is designed. The surround-view system provides driver 124 with a view from above on his or her vehicle 100, e.g., with the aid of four cameras 116, so that driver 124 is able to move his or her vehicle 100 in a virtual environment. A respective camera 116 is situated in each outside mirror and at the front, and a further camera 116 is situated on the rear of vehicle 100.

In addition to the use of camera system 114 for detecting when driver 124 approaches vehicle 100, system 102 for automatically opening door of interest 110 shown in FIG. 1 may be used in combination with a keyless unlocking system of vehicle 100. A corresponding device combines surround-view sensor 114 and the keyless unlocking system. When person 124 approaches vehicle 100, vehicle 100 is unlocked by the mechanism of the keyless unlocking system in the manner known until now. Surround-view system 114 is activated, detects person 124 approaching, and determines relevant door 110. If person 124 is moving toward this door 110, the same may be opened automatically by system 102. Instead of right rear door 110, it is also possible for trunk 112 to be activated and opened, for example. Prior to the opening of door 110, “opening range” 130 may optionally be monitored to prevent damage.

In one particular embodiment of device 102, the face of driver 124 or of dedicated persons may be “learned” by system 102, so that the function of automatically opening the door is only activated for the learned persons.

FIG. 2 shows a flow chart of one exemplary embodiment of a method 200 for opening a door of a vehicle, as it is described based on FIG. 1, for example. In a step 202, an authorization unit for use of the vehicle approaching the vehicle is identified. It is detected in a step 204 when the authorization unit approaches a relevant door of the vehicle. Based on steps 202 and 204, a unit for opening the relevant door is activated in a step 206.

Steps 202, 204, 206 of method 200 may be carried out in the units of the device which was described based on FIG. 1.

Algorithms used in exemplary embodiments of method 200 for general object detection and for tracking are under development or, in some instances, already in production use. For example, such algorithms are used to implement a rear end collision warning or a cross traffic alert. The existing image processing approaches could be used for the new function and expanded.

The concept introduced herein is directly verifiable in the product via the functionality. Such a functionality would be listed in the manual and, if necessary, even advertised.

The described exemplary embodiments shown in the figures are selected only by way of example. Different exemplary embodiments may be combined with each other completely or with respect to individual features. It is also possible to supplement one exemplary embodiment with features of another exemplary embodiment. Moreover, method steps according to the present invention may be carried out repeatedly and in a different order than the one described. If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

1-10. (canceled)

11. A method for automatically opening a door of a vehicle, comprising:
identifying an authorization unit for use of the vehicle approaching the vehicle;
detecting an approach of the authorization unit to a relevant door of the vehicle; and
activating a unit for opening the relevant door.

12. The method as recited in claim 11, further comprising:
a step of ascertaining the relevant door, wherein a movement trajectory of the authorization device relative to the vehicle is detected in the step of detecting the approach of the authorization unit, and wherein in the step of ascertaining the relevant door, a door of the vehicle which is assignable to the movement trajectory is ascertained as the relevant door based on the movement trajectory of the authorization unit.

13. The method as recited in claim 12, wherein, in the step of ascertaining the relevant door, an approach profile which is assigned to the movement trajectory is selected from multiple approach profiles which are assigned to different doors of the vehicle to ascertain the relevant door.

14. The method as recited in claim 13, further comprising:
a facial detection of a person carrying the authorization unit; and
determining based on the facial detection whether the person carrying the authorization unit is a person authorized to use the vehicle;
wherein the unit for opening the relevant door is activated only if the person carrying the authorization unit is determined to be authorized to use the vehicle.

15. The method as recited in claim 14, wherein the person carrying the authorization unit is compared to a database of multiple authorized persons in the step of facial detection.

16. The method as recited in claim 14, further comprising:
checking a swing range of the relevant door, wherein the unit for opening the relevant door is activated in the step of activating only if the swing range of the relevant door is free of obstacles.

17. The method as recited in claim 16, wherein at least one of (i) the unit for opening the relevant door is stopped and (ii) an opening of the relevant door is stopped in the step of activating if a moving obstacle is detected in the swing range of the relevant door.

18. A device for automatically opening a door of a vehicle, comprising:
an identifying unit for identifying an authorization unit for use of the vehicle approaching the vehicle;
a detection unit for detecting an approach of the authorization unit to a relevant door of the vehicle; and
an opening unit for opening the relevant door.

19. The device as recited in claim 18, further comprising:
at least one optical sensor configured to perform at least one of (i) detection of approach of the authorization unit to a relevant door of the vehicle, (ii) detection of a movement trajectory of the authorization unit, (iii) a facial detection of a person carrying the authorization unit, and (iv) checking a swing range of the relevant door.

20. A non-transitory, computer-readable data storage medium storing a computer program having program codes which, when executed on a computer, perform a method for automatically opening a door of a vehicle, the method comprising:
identifying an authorization unit for use of the vehicle approaching the vehicle;
detecting an approach of the authorization unit to a relevant door of the vehicle; and
activating a unit for opening the relevant door.
